(19) United States
(12) Patent Application Publication
(10) Pub. No.: US 2026/0292377 A1
(43) Pub. Date: Sep. 24, 2026

(54) HYBRID OPTICAL-ELECTRIC INTERCONNECTION SYSTEM FOR LARGE-SCALE INTELLIGENT COMPUTING CENTER

(71) Applicant: Beijing University of Posts and Telecommunications, Beijing (CN)

(72) Inventors: Rentao GU, Beijing (CN); Xinyue LI, Beijing (CN); Yunxuan LI, Beijing (CN); Yuefeng JI, Beijing (CN)

(21) Appl. No.: 19/573,448

(22) Filed: Mar. 20, 2026

(30) Foreign Application Priority Data
Mar. 21, 2025 (CN) 202510346818.7

(51) Int. Cl. H04Q 11/00

(52) U.S. Cl. CPC H04Q 11/0071; H04Q 11/0005; H04Q 2011/0039

(57) ABSTRACT

The present disclosure provides a hybrid optical-electric interconnection system for a large-scale intelligent computing center, including: an intra-group switching system having a plurality of intra-group switching units and an inter-group switching system including at least one optical switch; wherein each optical switch in the inter-group switching system includes multiple pairs of dual-side ports and is configured to provide multiple optical path connections between opposite-side ports of the dual-side ports through a mapping configuration of the opposite-side ports of different pairs, two opposite-side ports of each optical path connection of the same switch can be respectively connected with uplink ports of the electric switches of different intra-group switching units based on a connection relationship between ports of the optical switches and the ports of the electric switches, and the mapping configuration is designed to enable inter-group optical path switching channels to be formed between different intra-group switching units.

### CROSS-REFERENCE TO RELATED APPLICATIONS

This application claims priority of Chinese Patent Application No. CN202510346818.7, filed on Mar. 21, 2025, which is hereby incorporated by reference in its entirety.

### TECHNICAL FIELD

The present disclosure relates to the field of communication technologies, and in particular, to a hybrid optical-electric interconnection system for a large-scale intelligent computing center.

### BACKGROUND

With the continuous advancement of large model technology, accelerating the development of the artificial intelligence (AI) industry and building a powerful computing data center (or called an intelligent computing center) to support large models become an important research and development direction for the future. An ultra-large-scale data volume and a distributed computing approach are the key characteristics of a large model training task, which pose new requirements for the networking of intelligent computing centers that support such new services: (1) a large-scale of connectivity: the large model training requires participation of a large scale of computing nodes, and the networking of the intelligent computing center needs to support efficient communication and cooperation among tens of thousands of computing nodes urgently; (2) High-capacity transmission: large-model training tasks require training large models on massive datasets, and meanwhile, the large-model is parameter-rich, and the capacity and the speed of channel transmission of the network of the intelligent computing center need to be increased; (3) guaranteeing of low-delay synchronization: frequent parameter synchronization and data interactions among the computing nodes make a communication delay become a service bottleneck, and the networking of the intelligent computing center needs to guarantee a low delay of the data interaction, thereby guaranteeing the high efficiency of the large-scale cluster training task.

Traditional data center architectures based on electric switching face issues such as bandwidth limitation, a delay bottleneck, or the like, making it difficult to meet the requirements of burst growth of traffic and high synchronization during large model training. The data center architectures based on electric packet switching include Spine-Leaf networks, Dragonfly networks, and Torus networks. In the Spine-Leaf networks, all leaf switches are equally connected to all spine switches to form a fully interconnected network. Although the Spine-Leaf networks have excellent bandwidth bisection performance, the network diameter is large, the communication hop numbers of intra-cluster nodes and inter-cluster nodes are inconsistent, and parameter synchronization must wait for the slowest node to complete before proceeding to the next iteration during the AI training process, so that computing resources may be wasted. In the Dragonfly network, the full connection between groups is completed in a direct connection manner, and although the delay can be effectively reduced, it is difficult to meet the expandability, and the communication performance of each synchronization algorithm is difficult to guarantee under the service requirement of the novel intelligent computing center. The Torus architecture is a multi-dimensional topological structure, and has the advantages of a simple structure, multiple paths, or the like, but the number of links and the delay inside the network are gradually increased with the increase of the network dimensions; in addition, the ring structure of the Torus architecture can bring a complex deadlock problem. These interconnection architectures cannot support the burst growth of the traffic in the data center during large-scale model training in performance, and have the problems of the bandwidth limitation, large energy consumption, the delay bottleneck, a switching capacity limitation, or the like, and a more efficient data center interconnection solution needs to be designed to solve the bottleneck of the electric switching network.

Compared with the electric packet switching, optical switching does not parse data packets during forwarding them, and a transceiver module is not required to be mounted for conversion between optical signals and electric signals. In the large-scale network, this characteristic can effectively reduce the overhead of frequent optical-electric conversion in the electric switching network and lowering the communication delay. However, optical switching devices and components are relatively expensive, require large investment and are difficult to operate and maintain. Therefore, currently, a hybrid optical-electric switching architecture with some electric packet switches replaced with optical switches is an architecture that is considered to be more suitable for the large-scale high computing power data center and has been put to practical use, and this architecture combines the advantages of the electric packet switch and the optical switch and balances performances and costs. For example, both the Helios architecture and the ReSaw architecture adopt a two-layer tree topological structure, access switches (electric switches) thereof are directly connected with a server and are responsible for local communication, and core switches consist of an electric packet switch and an optical switch. Some uplink ports of the access switch are connected to the electric packet switches, and some other uplink ports thereof are connected to the optical switch; for short-time burst traffic, an electric packet switching mode is adopted; for longer-time traffic with a high bandwidth requirement, an optical switching mode is used. Such architecture has multiple switching layers and a larger switching delay, but can realize data aggregation with a lower cost, and is quite suitable for a traditional data center service in which large traffic and small traffic coexist, north-south traffic is large and east-west traffic is small. However, an intelligent computing center requires any-to-any communication among large-scale, same-layer nodes internally, which impose high demands on east-west communication. This results in new traffic pattern with limited north-south traffic and substantial east-west traffic, therefore the traditional hybrid optical-electric architecture is unsuitable. In addition, the traditional hybrid optical-electric architecture cannot realize a flexible reconfiguration, the expandability and the smooth upgrading capability of the architecture are weak. As a result, it is difficult to support the large-scale cluster interconnection training service, so that it is difficult to process complex data processing requirements efficiently. Therefore, how to realize the interconnection of a large scale of GPU cards and construct a flat and non-blocking intelligent computing center network architecture with a deployment cost advantage and a rigid-pipeline flexible adaptation capability for the large model training requirement becomes an important challenge of the current intelligent computing center.

### SUMMARY

In view of this, embodiments of the present disclosure provide a novel hybrid optical-electric interconnection system for a large-scale intelligent computing center, so as to eliminate or mitigate one or more defects existing in the prior art.

In an aspect, the present disclosure provides a hybrid optical-electric interconnection system for a large-scale intelligent computing center, including: an intra-group switching system and an inter-group switching system, wherein the intra-group switching system includes a plurality of intra-group switching units, and the inter-group switching system includes at least one optical switch;
each intra-group switching unit includes a first number of electric switches and at least one server, each server at least has a first number of computing nodes corresponding to the first number of electric switches, the first number of computing nodes are interconnected, and each electric switch is connected with the corresponding computing node in the first number of computing nodes through a downlink port;
each optical switch in the inter-group switching system includes multiple pairs of dual-side ports, the multiple pairs of dual-side ports are configured to provide multiple optical path connections between opposite-side ports of different pairs through a mapping configuration of opposite-side ports of different pairs, two opposite-side ports of each optical path connection of the same switch can be respectively connected with uplink ports of the electric switches of different intra-group switching units based on a connection relationship between ports of the optical switches and ports of the electric switches, and the mapping configuration is designed to enable inter-group optical path switching channels to be formed between different intra-group switching units.

In some embodiments of the present disclosure, the first number of computing nodes of the server of the intra-group switching unit are interconnected using a high-speed interconnection technology.

In some embodiments of the present disclosure, the intra-group switching system and the inter-group switching system are interconnected by single-fiber bi-directional optical modules for data transmission.

In some embodiments of the present disclosure, the number of the downlink ports of each electric switch in the intra-group switching unit is greater than or equal to the number of the servers in the corresponding intra-group switching unit.

In some embodiments of the present disclosure, the electric switches of the intra-group switching unit and the computing nodes inside the server establish the correspondence through a mapping relationship between electric switch identifiers and computing node identifiers.

In some embodiments of the present disclosure, the connection relationship between the ports of the optical switches and the ports of the electric switches includes: the same pair of dual-side ports in the optical switch are respectively connected with different uplink ports of the electric switch in the same intra-group switching unit; the mapping configuration includes establishment of a one-to-one corresponding mapping relationship between opposite-side ports of different pairs of the dual-side ports.

In some embodiments of the present disclosure, a total number of pairs of the dual-side ports of the optical switches of the inter-group switching system is greater than or equal to a second number, and at least one optical path connection can be established between any two intra-group switching units, the second number being N*(N−1)/2; the number of the optical switches in the inter-group switching system satisfies the following formula:

$${\sum }_{o = 1}^{O} {n}_{o} \geq \frac{N ( N - 1 )}{2} ;$$

or, the total number of pairs of the dual-side ports of the optical switches of the inter-group switching system is less than the second number, and an optical path connection is established between selected intra-group switching units; the number of the optical switches in the inter-group switching system satisfies the following formula:

$${\sum }_{o = 1}^{O} {n}_{o} < \frac{N ( N - 1 )}{2} ;$$

wherein N is the number of the intra-group switching units in the intra-group switching system, O is the number of the optical switches, and nₒ is the number of pairs of the dual-side ports in the oth optical switch.

In some embodiments of the present disclosure, the mapping configurations of the opposite-side ports of the optical switches of the inter-group switching system can be switched according to service transmission requirements of different intra-group switching units, so as to implement switching of connection optical paths.

In the embodiment of the present disclosure, the computing node is configured to send and receive data information required to be subjected to interactions; the electric switch of the same intra-group switching unit is configured to receive the data information sent from the corresponding computing node and forward the data information to the connected optical switch of the inter-group switching system, or configured to receive data information sent from the connected optical switch of the inter-group switching system and forward the data information to the corresponding computing node; the optical switch is configured to receive the data information from the electric switch and forward the received data information among different intra-group switching units.

In the hybrid optical-electric interconnection system for a large-scale intelligent computing center according to the present disclosure, the electric switches of the intra-group switching system provide flexible switching for the computing nodes in the same group in terms of flexibility. Meanwhile, the inter-group optical switches provide a high-capacity low-delay data transmission channel for the cross-group computing nodes, the optical path can be flexibly established through a service-oriented dynamic resource scheduling method, and adaptive connection and switching capacities are provided for services. In terms of the construction cost, the input optical switches have a smooth upgrading capability, and when the number of the optical path connections provided by the actually input optical switches is larger than a basic optical path connection number requirement, a transmission channel with a larger capacity can be provided among the intra-group switching units in the present disclosure; when the number of the optical path connections provided by the actually input optical switches is smaller than the basic optical path connection number requirement, an adaptive optical path can be constructed for the service by using the flexible switchable capability of the optical switches. Compared with other network interconnection systems of data centers, the system according to the present disclosure is low in construction cost and more flexible.

Additional advantages, objects and features of the present disclosure will be set forth in part in the description which follows and in part will become apparent to those having ordinary skill in the art upon examination of the following or may be learned from practice of the present disclosure. The objects and other advantages of the present disclosure will be achieved and attained by the structure particularly pointed out in the specification and drawings.

It will be appreciated by those skilled in the art that the objects and advantages that can be achieved with the present disclosure are not limited to what has been particularly described hereinabove, and that the above and other objects that can be achieved with the present disclosure will be more clearly understood from the following detailed description.

### BRIEF DESCRIPTION OF THE DRAWINGS

The accompanying drawings described herein are used to provide a further understanding of the present disclosure, constitute a part of the present application, and do not limit the present disclosure.

FIG. 1 is a schematic structural diagram of an intra-group switching unit in a hybrid optical-electric interconnection system according to an embodiment of the present disclosure.

FIG. 2 is a schematic diagram of interconnection between computing nodes of servers in an embodiment of the present disclosure.

FIG. 3 is a schematic diagram of optical path connections in an optical switch of an inter-group switching system in an embodiment of the present disclosure.

FIG. 4 is a schematic diagram of interconnection between the intra-group switching units of an intra-group switching system and the optical switches of the inter-group switching system in the hybrid optical-electric interconnection system according to an embodiment of the present disclosure.

FIG. 5 is a schematic diagram of interconnection between the intra-group switching units of the intra-group switching system and the optical switches of the inter-group switching system in the hybrid optical-electric interconnection system according to another embodiment of the present disclosure.

FIG. 6 is a schematic diagram of interconnection between the intra-group switching units of the intra-group switching system and the optical switches of the inter-group switching system in the hybrid optical-electric interconnection system according to another embodiment of the present disclosure.

FIG. 7 is a schematic diagram of interconnection between the intra-group switching units of the intra-group switching system and the optical switches of the inter-group switching system in the hybrid optical-electric interconnection system according to another embodiment of the present disclosure.

### DETAILED DESCRIPTION

In order to make the objectives, technical solutions and advantages of the present disclosure more apparent, the present disclosure is described in further detail below with reference to the embodiments and the accompanying drawings. Herein, the exemplary embodiments of the present disclosure and the descriptions thereof are used to explain the present disclosure, but not to limit the present disclosure.

It should also be noted herein that, in order to avoid obscuring the present disclosure with unnecessary details, only the structures and/or processing steps closely related to the solution according to the present disclosure are shown in the drawings, and other details not so related to the present disclosure are omitted.

It should be emphasized that the term “includes/comprises” when used herein, is taken to specify the presence of features, elements, steps or components, but does not preclude the presence or addition of one or more other features, elements, steps or components.

Here, it is also noted that, unless otherwise specified, the term “connected” is used herein to refer not only to direct connections, but also to indirect connections with an intermediate.

Hereinafter, embodiments of the present disclosure will be described with reference to the drawings. In the drawings, the same reference numerals denote the same or similar components or the same or similar steps.

To address the difficulty of existing intelligent computing centers in meeting the requirements of numerous connections, large bandwidth and low delay of large model training under time-varying conditions, the present disclosure provides a novel hybrid optical-electric interconnection system for a large-scale intelligent computing center, so as to realize a low-cost topological structure for supporting a large scale of connections under the characteristic of an optical interconnection rigid pipeline. The novel hybrid optical-electric interconnection system according to the disclosure includes an intra-group switching system and an inter-group switching system, wherein the intra-group switching system includes a plurality of intra-group switching units, each intra-group switching unit includes a server and a plurality of electric switches (also called electric packet switches), the server has a plurality of interconnected computing nodes, and the inter-group switching system includes one or more optical switches. The electric switches of the intra-group switching unit provide flexible data synchronization for the computing nodes. The inter-group optical switches provide rigid channels for inter-group data switching of the computing nodes by using the characteristics of large bandwidth, low delay, or the like, of an optical link, and meanwhile, a flexible reconfiguration capability of the optical switch can be used for flexible adaptation to services. The intra-group switching unit preferably has a plurality of servers which are interconnected. The interconnection of the computing nodes in a single server is used to improve the efficiency of data processing and communication in the server; the interconnection between the servers may ensure efficient data switching between the servers within the same group.

The hybrid optical-electric interconnection system for a large-scale intelligent computing center according to the present disclosure includes an intra-group switching system and an inter-group switching system, wherein the intra-group switching system includes a plurality of intra-group switching units (or called a plurality of groups), and the inter-group switching system includes at least one optical switch.

Each intra-group switching unit includes a first number of electric switches and at least one server, each server at least has a first number of computing nodes corresponding to the first number of electric switches, and the first number of computing nodes are interconnected. Any electric switch of each intra-group switching unit is connected to one computing node on each intra-group server. For example, a corresponding relationship may be preset, so that each electric switch of the intra-group switching unit is connected to the corresponding computing node in the first number of computing nodes in the group through a downlink port.

The number of the intra-group switching units may be denoted as N which is a natural number. As an example, N=5. That is, the intra-group switching system includes 5 intra-group switching units, or the intra-group switching system is divided into 5 groups, numbers thereof are G₁, G₂, . . . , Gᵢ, . . . , G_{N}, and Gᵢ denotes the ith group. Each intra-group switching unit includes M electric switches numbered E₁, E₂, . . . , Eₘ, . . . , E_{M}, and L servers numbered S₁, S₂, . . . , Sₗ, . . . , S_{L}, wherein Eₘ represents the mth electric switch and St represents the Ith server. Each electric switch in the group may include P switching ports, and each server includes M computing nodes numbered C₁, C₂, . . . , Cₘ, . . . , C_{M}, wherein Cₘ represents the mth computing node. Each computing node numbered Cₘ can be respectively connected with the downlink port of the electric switch numbered Eₘ in the group through a network port.

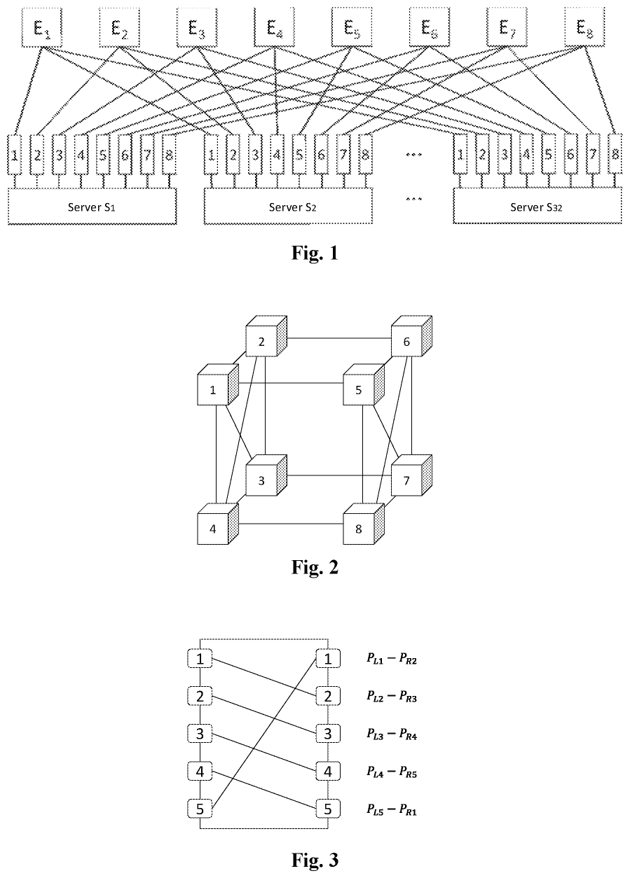

As shown in FIG. 1, M=8 and L=32. That is, each intra-group switching unit of the intra-group switching system includes 8 electric switches (E₁-E₈) and 32 servers (S₁-S₃₂), the number P of the ports of each electric switch is 64, for example, each server includes 8 computing nodes (C₁-C₈, in the example of FIG. 1, C₁=1, . . . , and C₈=8), the computing nodes may be GPUs inside the servers, the computing nodes inside the same server are connected to each other, as shown in FIG. 2, and the connection may be a direct connection or an indirect connection. As an example, the computing nodes within the same server may be connected and communicated with each other using high-speed interconnection technology (e.g., NVLink). In the embodiment of the present disclosure, any electric switch of one intra-group switching unit is connected to one computing node on each intra-group server.

The inter-group switching system may include one or more optical switches, each optical switch includes multiple pairs of dual-side ports (e.g., n pairs), the multiple pairs of dual-side ports can be pre-configured with a mapping configuration, through which multiple optical path connections are provided between opposite-side ports of different pairs of the dual-side ports, and two opposite-side ports of each optical path connection of the same optical switch can be respectively connected to uplink ports of the electric switches of different intra-group switching units. The mapping configuration causes inter-group optical path switching channels to be formed between different intra-group switching units. In the embodiments of the present disclosure, the intra-group switching system and the inter-group switching system are interconnected by single-fiber bi-directional optical modules for data transmission. In the embodiments of the present disclosure, the mapping configuration includes establishment of a one-to-one corresponding mapping relationship between opposite-side ports of different pairs of the dual-side ports.

The intra-group switching unit and the inter-group optical switches may be respectively configured to realize the following operations:
The computing nodes are configured to send and receive data information required to be subjected to interactions;
each electric switch of the same intra-group switching unit is configured to receive the data information sent from the corresponding computing node and forward the data information to the connected optical switch of the inter-group switching system, or configured to receive data information sent from the connected optical switch of the inter-group switching system and forward the data information to the corresponding computing node;
the optical switch is configured to receive the data information from the electric switches and forward the received data information among different intra-group switching units.

In the above novel hybrid optical-electric interconnection system for a large-scale intelligent computing center, in the P ports of each electric switch in one intra-group switching unit, L downlink ports are configured to be connected with the computing nodes, and (P-L) uplink ports are configured to be interconnected with the inter-group optical switches. In some embodiments of the present disclosure, the number L of the downlink ports of each electric switch in the intra-group switching unit is greater than or equal to the number of the servers in the corresponding intra-group switching unit. In addition to the downlink ports connected to the computing nodes in the server and the uplink ports connected to the optical switches, the electric switch may be provided with redundant or spare uplink/downlink ports, and the specific number is not limited in the present disclosure as long as the requirements of the connections with the computing nodes and the optical switches can be met.

In the embodiments of the present disclosure, the electric switches of the intra-group switching unit and the computing nodes inside the servers establish the correspondence through a mapping relationship between electric switch identifiers (such as electric switch numbers) and computing node identifiers (such as computing node numbers). Any electric switch of one intra-group switching unit can be connected with one computing node on each intra-group server by: mapping the computing nodes in the intra-group servers S₁, S₂, S₃, . . . , S_{L} with the intra-group electric switches, and respectively connecting the computing node Cₘ with the corresponding electric switch Eₘ through a network port. As an example, a feasible mapping method includes: connecting the same-numbered computing nodes on different servers to the same electric switch through the network ports, that is, connecting all the computing nodes numbered 1 in the 32 servers in the group with the electric packet switch numbered 1 through the first network ports of the servers respectively; respectively connecting all the computing nodes numbered C₂ (e.g., C₂=2) with the electric packet switch numbered E₂ (e.g., E₂=2) through the second network ports of respective servers; repeating the operation until all the computing nodes numbered Cₘ (e.g., Cₘ=m) are connected to the electric switch numbered Eₘ (e.g., Eₘ=m) through the mth network ports of respective servers. The mapping method is only an example, and the present disclosure is not limited thereto.

In the embodiment of the present disclosure, the inter-group switching system may include 0 optical switches numbered A₁, A₂, A₃, . . . , Aₒ, . . . , A₀, Aₒ represents the oth optical switch, and each optical switch may include multiple pairs of dual-side switching ports, for example, no pairs of dual-side ports, that is, there are no ports on each side, there are 2nₒ dual-side ports in total, and no denotes the number of single-side ports of the oth optical switch. The numbers of the dual-side ports of different optical switches may be the same or different. As an example, if one inter-group optical switch has n pairs of dual-side ports, the left ports may be denoted as P_{L1}, P_{L2}, . . . , P_{Li}, . . . , P_{Ln}, and the right ports may be denoted as P_{R1}, P_{R2}, . . . , P_{Ri} . . . , P_{Rn}, wherein P_{Li} denotes the left ith port, P_{Ri} denotes the right ith port, and P_{Li}−P_{Ri} is one pair of dual-side ports.

In the embodiment of the present disclosure, the multiple pairs of dual-side ports are configured to form multiple groups of dual-side ports through the mapping configuration of opposite-side ports belonging to different pairs, and the multiple groups of dual-side ports are configured to provide multiple optical path connections between opposite-side ports of different pairs. That is, each group of dual-side ports is formed by the opposite-side ports in different pairs of ports, and one optical path connection is formed between this group of opposite-side ports. Each group of dual-side ports (i.e., two opposite-side ports connected by each optical path) of the same optical switch can be respectively connected to the uplink ports of the electric switches of different intra-group switching units based on the connection relationship between the ports of the optical switches and the ports of the electric switches, and the mapping configuration causes the inter-group optical path switching channels to be formed between different intra-group switching units. As an example, inside the optical switch, if one pair of dual-side ports is represented by P_{Li}−P_{Ri}, P_{Li}−P_{Ri} may be used to represent one group of dual-side ports including the left ith port and the right jth port (i≠j), an optical path connection may be formed between the group of configured dual-side ports, and the ports on the same side cannot be connected; at any moment, the optical switch with n groups of ports may provide n optical path connections. In order to facilitate the flexible mapping configuration of multiple groups of dual-side ports, in the embodiment of the present disclosure, preferably, the connection relationship between the ports of the optical switches and the ports of the electric switches may be predetermined or determined in real time, and the connection relationship may include the following content: the same pair of dual-side ports of the same optical switch may be respectively connected to different uplink ports of the electric switches of the same intra-group switching unit. More specifically, the same pair of dual-side ports of the same optical switch may be connected with different uplink ports of the same electric switch of the same intra-group switching unit or may be connected with the uplink ports of different electric switches of the same intra-group switching unit. In some embodiments of the present disclosure, in addition to the switching port connected to the electric switch, the optical switch may be provided with redundant or spare switching ports, and the specific number is not limited in the present disclosure as long as the requirement of the connection with the electric switch can be met.

FIG. 3 shows an example of the optical path connection in one optical switch in the embodiment of the present disclosure. FIG. 3 shows the optical switch with n=5, which includes 2n dual-side ports, there are 5 ports on each of the left side and the right side, the ports on the left side and the right side are matched by numbers as 5 pairs of dual-side ports which are P_{L1}-P_{R1}, P_{L2}-P_{R2}, P_{L3}-P_{R3}, P_{L4}-P_{R4}, and P_{L5}-P_{R5} respectively. The 5 pairs of dual-side ports form 5 groups of dual-side ports for providing the optical path connections using the mapping configuration of opposite-side ports of different pairs. More specifically, the mapping configuration of the ports is as follows: the 5 groups of dual-side ports are mapped and configured to be P_{L1}-P_{R2}, P_{L2}-P_{R3}, P_{L3}-P_{R4}, P_{L4}-P_{R5} and P_{L5}-P_{R1}. That is, the left first port and the right second port serve as one group, and an optical path connection exists between the two ports; the left second port and the right third port serve as one group, and an optical path connection exists between the two ports; the left third port and the right fourth port serve as one group, and an optical path connection exists between the two ports; the left fourth port and the right fifth port serve as one group, and an optical path connection exists between the two ports; the left fifth port and the right first port serve as one group, and an optical path connection exists between the two ports, so that 5 optical path connections are provided. The optical switch performs data transmission with the intra-group electric packet switches through the single-fiber bi-directional optical module at the same wavelength. Optical paths of the optical switch have flexible reconfigurability. In order to facilitate the flexible mapping configuration of multiple groups of dual-side ports, in FIG. 3, the same pair of dual-side ports of the optical switch, such as P_{L1} and P_{R1}, may be connected to different uplink ports of the same electric switch or the uplink ports of different electric switches in the same intra-group switching unit respectively.

In some embodiments of the present disclosure, the total number of pairs of the dual-side ports of the optical switches of the inter-group switching system may be configured to be equal to N*(N−1)/2, wherein N is the number of the intra-group switching units in the intra-group switching system. In this case, one optical path connection may be established between any two intra-group switching units. At this point, the number of the optical switches in the inter-group switching system satisfies the following formula:

$${\sum }_{o = 1}^{O} {n}_{o} < \frac{N ( N - 1 )}{2} ;$$

wherein O is the number of the optical switches, and nₒ is the number of pairs of the dual-side ports in the oth optical switch.

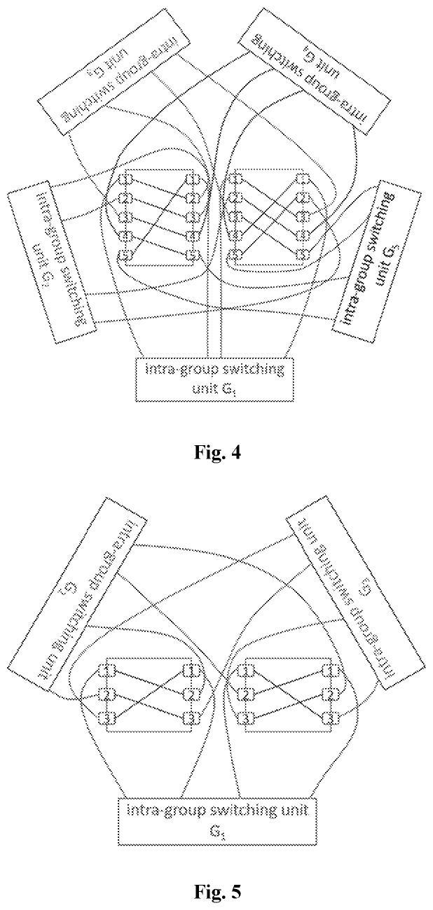

FIG. 4 is an example of the novel hybrid optical-electric interconnection system according to the present disclosure. As shown in FIG. 4, the number N of the intra-group switching units is 5, the number of the ports on one side is identical across all the optical switches, n=nₒ=5, o=1, 2, . . . , O, and the number of the optical switches satisfies:

$${\sum }_{o = 1}^{O} {n}_{o} = \frac{N ( N - 1 )}{2} ;$$

in the case where the numbers of the ports on one side of all the optical switches are equal, the number of the optical switches can be calculated as:

$$O = ⌈ \frac{N ( N - 1 )}{2 n} ⌉ = 2 .$$

In this case, the optical path connection is established between any two intra-group switching units through the optical switch, and the inter-group optical path switching channel can be provided for any two intra-group switching units. Specifically, in the two optical switches in FIG. 4, the first pairs of dual-side ports of the two optical switches are respectively connected to 4 different uplink ports of the electric switches in the intra-group switching unit G₁, and similarly, the second pairs, the third pairs, the fourth pairs and the fifth pairs of dual-side ports of the two optical switches are respectively connected to 4 different uplink ports of the electric switches in the intra-group switching units G₂, G₃, G₄ and G₅. Through the one-to-one corresponding mapping relationship (mapping configuration) established between opposite-side ports of different pairs of dual-side ports in the two optical switches, for example, the 5 groups of dual-side ports formed by one optical switch are respectively P_{L1}-P_{R2}, P_{L2}-P_{R3}, P_{L3}-P_{R4}, P_{L4}-P_{R5} and P_{L5}-P_{R1}, and the 5 groups of dual-side ports formed by the other optical switch are respectively P_{L1}-P_{R3}, P_{L2}-P_{R4}, P_{L3}-P_{R5}, P_{L4}-P_{R1} and P_{L5}-P_{R2}, the optical path connections are established between any two intra-group switching units through the optical switches. For instance, an optical path connection is established between the intra-group switching units G₁ and G₂ through one group of ports P_{L1}-P_{R2} of the left optical switch in FIG. 4, and an optical path connection is established between the intra-group switching units G₁ and G₃ through one group of ports P_{L1}-P_{R3} of the right optical switch in FIG. 4. It can be clearly seen in FIG. 4 that optical path connections are also established between every two other intra-group switching units through the optical switches, which are not listed individually here.

In some other embodiments of the present disclosure, the total number of pairs of the dual-side ports of the optical switches of the inter-group switching system may be configured to be greater than N*(N−1)/2, in which case one or more optical path connections may be established between any two of the intra-group switching units, which may provide a greater inter-group optical circuit switching bandwidth. At this point, the number of the optical switches in the inter-group switching system satisfies the following formula:

$${\sum }_{o = 1}^{O} {n}_{o} > \frac{N ( N - 1 )}{2} ;$$

in the case where the numbers of the ports on one side of all the optical switches are equal (nₒ=n), the number of the optical switches can be calculated as:

$$O > ⌈ \frac{N ( N - 1 )}{2 n} ⌉ .$$

FIG. 5 is an example of the novel hybrid optical-electric interconnection system according to the present application. As shown in FIG. 5, the number N of the intra-group switching units is 3, the numbers of the ports on one side of all the optical switches are equal, n=nₒ=3, and the number O of the optical switches is 2, that is, satisfies

$${\sum }_{o = 1}^{O} {n}_{o} > \frac{N ( N - 1 )}{2} ,$$

that is,

$$O > ⌈ \frac{N ( N - 1 )}{2 n} ⌉ .$$

In the two optical switches of FIG. 5, the first pairs of dual-side ports of the two optical switches are respectively connected to 4 different uplink ports of the electric switches in the intra-group switching unit G₁, and similarly, the second pairs and the third pairs of dual-side ports of the two optical switches are respectively connected to 4 different uplink ports of the electric switches in the intra-group switching units G₂ and G₃. Through the one-to-one corresponding mapping relationship (mapping configuration) established between opposite-side ports of the different pairs of the dual-side ports of the two optical switches, the 3 groups of dual-side ports formed by the two optical switches are respectively P_{L1}-P_{R2}, P_{L2}-P_{R3} and P_{L3}-P_{R1} as well as P_{L1}-P_{R3}, P_{L2}-P_{R1} and P_{L3}-P_{R2}. One optical path connection between any two intra-group switching units is established through the grouped dual-side ports by mapping in each optical switch, and therefore, two optical path connections between any two intra-group switching units are established through the grouped dual-side ports by mapping in the two optical switches, thereby providing more data transmission channel choices for the computing nodes across the groups. These transmission channels may be used simultaneously or partially, and these transmission channels may construct adaptive optical paths for different services through switching of the optical paths inside the switch. In alternative embodiments of the present disclosure, a different number of optical path connections may be established between different intra-group switching units based on service requirements, so that more or fewer optical path connections are established between specific intra-group switching units. For example, only one optical path connection may be established between the intra-group switching units Gᵢ and G₂, and 3 optical path connections may be established between the intra-group switching units G₂ and G₃, which are only examples and are not intended to limit the present disclosure.

In some other embodiments of the present disclosure, the total number of pairs of the dual-side ports of the optical switches of the inter-group switching system may be configured to be smaller than N*(N−1)/2. In this case, the optical path connections cannot be established simultaneously between any two intra-group switching units, but the optical path connections can be established between selected intra-group switching units, and adaptive optical paths can be constructed for the services using the flexible switchable capability of the optical switch. At this point, the number of the optical switches in the inter-group switching system satisfies the following formula:

$${\sum }_{o = 1}^{O} {n}_{o} < \frac{N ( N - 1 )}{2} and 0 = 1 , 2 , … , O .$$

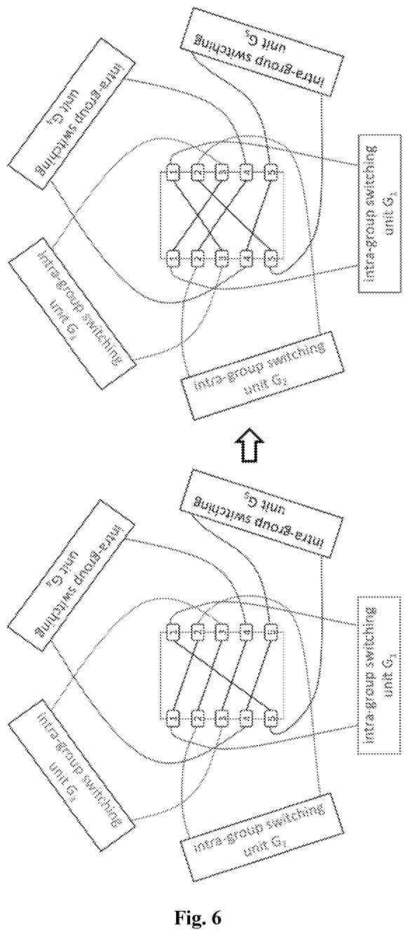

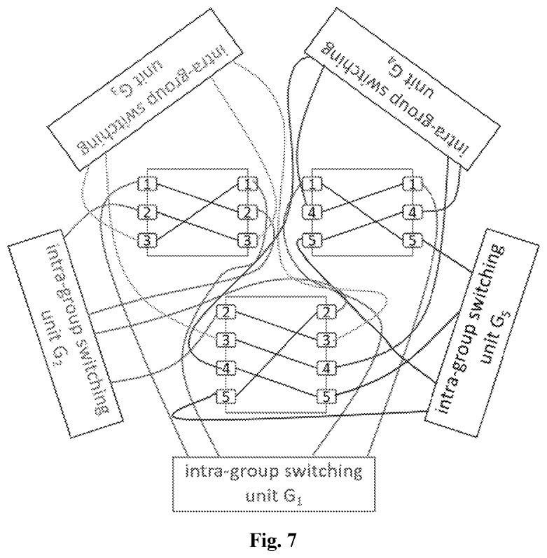

FIG. 6 is an example of the novel hybrid optical-electric interconnection system according to the present application. As shown in FIG. 6, the number N of the intra-group switching units is 5, the numbers of the ports on one side of all the optical switches are equal, n=nₒ≤5, and the number of the optical switches satisfies:

$${\sum }_{o = 1}^{O} {n}_{o} < \frac{N ( N - 1 )}{2} ;$$

at this point, the number of the optical switches may be calculated as:

$$O < ⌈ \frac{N ( N - 1 )}{2 n} ⌉ ,$$

that is, O=1;
wherein nₒ=n=5, and o=1.

The first to fifth pairs of dual-side ports of the optical switch in FIG. 6 are connected to 2 different uplink ports of the electric switches in the intra-group switching units Gᵢ to G₅ respectively. The one-to-one corresponding mapping relationship is established between opposite-side ports of different pairs of the dual-side ports of the optical switch through the mapping configuration on the left of FIG. 6, and optical path connections between the two intra-group switching units G₁ and G₂, G₂ and G₃, G₃ and G₄, G₄ and G₅, and G₅ and Gᵢ are respectively established through the 5 groups of dual-side ports P_{L1}-P_{R2}, P_{L2}-P_{R3}, P_{L3}-P_{R1}, P_{L4}-P_{R5} and P_{L5}-P_{R1} formed by the optical switch, that is, the optical path connections are established between specific intra-group switching units, but the optical path connections are not established between any two intra-group switching units. In this case, by using the flexible switching capability of the optical switching technology (OCS), an adaptive optical path may be constructed for the services between other intra-group switching units through the switching of the optical paths inside the switch, so as to implement service transmission between the other intra-group switching units. For example, the left mapping configuration in FIG. 6 is changed into the right mapping configuration in FIG. 6 to perform optical path switching, and the 5 groups of dual-side ports P_{L1}-P_{R3}, P_{L2}-P_{R4}, P_{L3}-P_{R1}, P_{L4}-P_{R5} and P_{L5}-P_{R2} formed by the modified mapping configuration can respectively establish optical path connections between two selected intra-group switching units G₁ and G₃, G₂ and G₄, G₃ and G₁, G₄ and G₅, and G₅ and G₂, thereby meeting the requirements of service transmission between these intra-group switching units.

When there are a plurality of optical switches in the inter-group switching system, the numbers of the switching ports of different optical switches may be the same or different. FIG. 4 to FIG. 6 show the examples where the numbers of the switching ports of different optical switches in the system are the same, and FIG. 7 shows an example where the numbers of the switching ports of different optical switches in the system are different.

As shown in FIG. 7, the number N of the intra-group switching units is 5, the system includes 3 optical switches (O=3), the numbers of the ports on one side of the optical switches are n₁=n₂=3, and n₃=4, and the number of the optical switches satisfies

$${\sum }_{k = 1}^{O} {n}_{k} = \frac{N ( N - 1 )}{2} .$$

FIG. 7 shows a case where the numbers of the ports of the optical switches are different. As can be seen from FIG. 7, the optical path connections exist between any two different intra-group switching units, and may provide the inter-group optical path switching channels for the corresponding intra-group switching units.

In the embodiment of the present disclosure, no matter whether the optical switch is arranged in the hybrid optical-electric interconnection system according to

$${\sum }_{o = 1}^{O} {n}_{o} \geq \frac{N ( N - 1 )}{2} or {\sum }_{o = 1}^{O} {n}_{o} < \frac{N ( N - 1 )}{2} ,$$

the mapping configurations of the opposite-side ports of the optical switches can be flexibly switched according to the transmission requirements of different intra-group switching units.

For the service characteristics of limited north-south traffic and substantial east-west traffic in the intelligent computing center, as a convergence layer switch, the optical switch can provide the adaptive transmission channel for data transmission provided by the intelligent computing service due to the characteristics of a large bandwidth and a low delay. Since the intelligent computing service presents certain periodicity, burstiness and discontinuity, when the number of the optical path connections actually provided by the optical switch is smaller than the basic connection requirement (for example, there needs to be one optical path connection for any intra-group switching unit), the connection optical paths can be reconstructed in time through the mapping configuration of the opposite-side ports of the optical switch according to the service requirement, so as to find the adaptive optical path connections for the service. Furthermore, when the number of possible optical path connections that can be provided by the optical switch is greater than the basic connection requirement of inter-group switching, the reconfigurability of the optical switch can be used to provide more connections than required connections between two intra-group switching units, thereby providing a larger transmission bandwidth.

The hybrid optical-electric interconnection system for a large-scale intelligent computing center according to the present disclosure is designed based on the data interaction requirement of the large-model training service, and one intra-group switching unit includes the interconnections in the computing nodes and the interconnection among the intra-group servers. The interconnection of the computing nodes in the servers is used for improving the data processing and communication efficiency in a single server; the interconnection between the servers may ensure efficient data switching between the servers within the same group. The inter-group switching system is responsible for data flow and coordination among different groups, and an efficient, expandable and stable network architecture is integrally formed, so that the requirements of large-scale cluster computing and complex data processing can be supported.

Furthermore, the present disclosure proceeds from the requirements for flexibility and construction cost, and the electric switches of the intra-group switching system provide flexible switching for the computing nodes in the same group in terms of flexibility. Meanwhile, the inter-group optical switches provide high-capacity low-delay data transmission channels for the cross-group computing nodes, the optical paths can be flexibly established through the service-oriented dynamic resource scheduling method implemented through the hybrid optical-electric hybrid interconnection system, and adaptive connections and switching capacities are provided for services. In terms of the construction cost, the deployed optical switches have a smooth upgrading capability, and when the number of the optical path connections provided by the actually deployed optical switches is larger than a basic optical path connection number requirement, a transmission channel with a larger capacity can be provided among the intra-group switching units in the present disclosure; when the number of the optical path connections provided by the actually deployed optical switches is smaller than the basic optical path connection number requirement, the adaptive optical paths can be constructed for the service by using the flexible switchable capability of the optical switches. Compared with other network interconnection systems of data centers, the present disclosure has a lower construction cost and is more advantageous.

Those of ordinary skill in the art should appreciate that the various exemplary components, systems and methods described in connection with the embodiments disclosed herein may be implemented in hardware, software, or combinations thereof. Whether they are implemented in hardware or software depends upon particular applications and design constraints of the technical solution. Professionals may use different methods for particular applications to achieve the described functions, but such implementations should not be considered beyond the scope of the present disclosure. When implemented in hardware, the elements of the present disclosure may be, for example, an electronic circuit, an application specific integrated circuit (ASIC), suitable firmware, plug-in, a function card, or the like. When implemented in software, the elements of the present disclosure are programs or code segments used to perform required tasks. The programs or the code segments can be stored in a machine-readable medium or transmitted by a data signal carried in a carrier wave over a transmission medium or a communication link.

It is to be understood that the present disclosure is not limited to the particular configurations and processing described above and shown in the drawings. A detailed description of known methods is omitted herein for the sake of brevity. In the above embodiments, several specific steps are described and shown as an example. However, the method processes of the present disclosure are not limited to the specific steps described and shown, and those skilled in the art can make various changes, modifications and additions, or change the order between the steps, after comprehending the spirit of the present disclosure.

Features that are described and/or illustrated with respect to one embodiment may be used in the same way or in a similar way in one or more other embodiments and/or in combination with or instead of the features of the other embodiments in the present disclosure.

The above description is only a preferred embodiment of the present disclosure and is not intended to limit the present disclosure, and various modifications and changes may be made to the embodiment of the present disclosure by those skilled in the art. Any modifications, equivalents and improvements made within the spirit and principle of the present disclosure should be included in the protection scope of the present disclosure.

1. A hybrid optical-electric interconnection system for a large-scale intelligent computing center, comprising: an intra-group switching system and an inter-group switching system, wherein the intra-group switching system comprises a plurality of intra-group switching units, and the inter-group switching system comprises at least one optical switch;
each intra-group switching unit comprises a first number of electric switches and at least one server, each server at least has a first number of computing nodes corresponding to the first number of electric switches, the first number of computing nodes are interconnected, and each electric switch is connected with the corresponding computing node in the first number of computing nodes through a downlink port;
each optical switch in the inter-group switching system comprises multiple pairs of dual-side ports, the multiple pairs of dual-side ports are configured to provide multiple optical path connections between opposite-side ports of different pairs through a mapping configuration of opposite-side ports of different pairs, two opposite-side ports of each optical path connection of the same switch can be respectively connected with uplink ports of the electric switches of different intra-group switching units based on a connection relationship between ports of the optical switch and ports of the electric switches, and the mapping configuration is designed to enable inter-group optical path switching channels to be formed between different intra-group switching units.

2. The system according to claim 1, wherein the first number of computing nodes of the server of the intra-group switching unit are interconnected using high-speed interconnection technology.

3. The system according to claim 1, wherein the intra-group switching system and the inter-group switching system are interconnected by single-fiber bi-directional optical modules for data transmission.

4. The system according to claim 1, wherein the number of the downlink ports of each electric switch in the intra-group switching unit is greater than or equal to the number of the servers in the corresponding intra-group switching unit.

5. The system according to claim 1, wherein the electric switches of the intra-group switching unit and the computing nodes inside the server establish the correspondence through a mapping relationship between electric switch identifiers and computing node identifiers.

6. The system according to claim 1, wherein the connection relationship between the ports of the optical switch and the ports of the electric switches comprises: the same pair of dual-side ports in the optical switch are respectively connected with different uplink ports of the electric switches in the same intra-group switching unit;
the mapping configuration comprises establishment of a one-to-one corresponding mapping relationship between opposite-side ports of different pairs of the dual-side ports.

7. The system according to claim 1, wherein the total number of pairs of the dual-side ports of the optical switch of the inter-group switching system is greater than or equal to a second number, and at least one optical path connection can be established between any two intra-group switching units, the second number being N*(N−1)/2; wherein Nis the number of the intra-group switching units in the intra-group switching system;
the number of the optical switches in the inter-group switching system satisfies the following formula:
$${\sum }_{o = 1}^{O} {n}_{o} \geq \frac{N ( N - 1 )}{2} ;$$
wherein O is the number of the optical switches, and nₒ is the number of pairs of the dual-side ports in the oth optical switch.

8. The system according to claim 1, wherein the total number of pairs of the dual-side ports of the optical switch of the inter-group switching system is smaller than the second number, and optical path connections are established between selected intra-group switching units, the second number being N*(N−1)/2; wherein N is the number of the intra-group switching units in the intra-group switching system;
the number of the optical switches in the inter-group switching system satisfies the following formula:
$${\sum }_{o = 1}^{O} {n}_{o} < \frac{N ( N - 1 )}{2} ;$$
wherein O is the number of the optical switches, and no is the number of pairs of the dual-side ports in the oth optical switch.

9. The system according to claim 7, wherein the mapping configurations of the opposite-side ports of the optical switch of the inter-group switching system are switched according to service transmission requirements of different intra-group switching units, so as to implement switching of connection optical paths.

10. The system according to claim 8, wherein the mapping configurations of the opposite-side ports of the optical switches of the inter-group switching system are switched according to service transmission requirements of different intra-group switching units, so as to implement switching of connection optical paths.

11. The system according to claim 1,
wherein the computing nodes are configured to send and receive data information required to be subjected to interactions;
the electric switch of the same intra-group switching unit is configured to receive the data information sent from the corresponding computing node and forward the data information to the connected optical switch of the inter-group switching system, or configured to receive data information sent from the connected optical switch of the inter-group switching system and forward the data information to the corresponding computing node;
the optical switch is configured to receive the data information from the electric switch and forward the received data information among different intra-group switching units.
